(19) United States
(12) Patent Application Publication
(10) Pub. No.: US 2010/0202301 A1
(43) Pub. Date: Aug. 12, 2010

(54) METHOD FOR SWITCHING BETWEEN A LONG GUARD INTERVAL AND A SHORT GUARD INTERVAL AND MODULE USING THE SAME

(75) Inventors: CHUN HSIEN WEN, HSINCHU COUNTY (TW); YUNG SZU TU, HSINCHU COUNTY (TW); YEN CHIN LIAO, HSINCHU COUNTY (TW); JIUNN TSAIR CHEN, HSINCHU COUNTY (TW)

Correspondence Address: WPAT, PC;INTELLECTUAL PROPERTY ATTORNEYS, 2030 MAIN STREET, SUITE 1300, IRVINE, CA, 92614, US

(73) Assignee: RALINK TECHNOLOGY CORPORATION, HSINCHU COUNTY (TW)

(21) Appl. No.: 12/486,503

(22) Filed: Jun. 17, 2009

(30) Foreign Application Priority Data
Feb. 12, 2009 (TW) 098104424

(51) Int. Cl. H04L 12/26; H04L 27/28

(52) U.S. Cl. 370/252; 375/260

(57) ABSTRACT

The module for switching between a long guard interval and a short guard interval comprises a signal processing unit, a measurement unit, a comparison unit and a switching unit. The module receives a first data symbol, and the data symbol has one of a long guard interval and a short guard interval. The signal processing unit is configured to generate a second data symbol in accordance with the first data symbol. The measurement unit is configured to measure a portion of the first and second data symbols in order to generate a first measurement value and a second measurement value. The comparison unit is configured to generate an output signal by comparing the first and second measurement values with a threshold value. The switching unit is configured to selectively switch guard intervals of subsequent data symbols in accordance with the output signal.

### BACKGROUND OF THE INVENTION

1. Field of the Invention

The present invention relates to a method for switching between a long guard interval and a short guard interval and the module using the same, and more particularly, to a method for switching between a long guard interval and a short guard interval and the module using the same which are applied to an orthogonal frequency division multiplexing (OFDM) system.

2. Description of the Related Art

Generally, under the limitation of a fixed bandwidth, a communication system can use a single carrier or multiple carriers for transmission. Single carrier transmission transmits a data stream on a single carrier channel, while multi-carrier transmission transmits data stream through multiple subcarriers with low data rates. OFDM is a current system of multi-carrier transmissions. The OFDM method divides an original data stream with a high-speed data rate into several data streams with low-speed data rates, and uses subcarriers each orthogonal to one another. With a multi-path effect, inter-symbol interference (ISI) might happen due to channel delay spread. FIG. 1A shows a data frame 10 in the time domain, where the data frame 10 is composed of multiple continuous data symbols 12A to 12N. FIG. 1B further describes each data symbol in detail, wherein the data symbols 12A to 12N have the same formats in the time domain. Each of data symbols 12A to 12N in FIG. 1B includes a cyclic prefix 14 having a guard interval T_{GI} and an effective data 16 having a symbol duration T. To reduce the above inter-symbol interference, when transmitting, a transmitter usually adds the cyclic prefix 14 to the effective data 16 through a GI insertion unit to constitute the data symbols 12A to 12N. As shown in FIG. 1B, the cyclic prefix 14 is equal to the tail portion of the effective data 16. In addition, the guard interval T_{GI} must be greater than a channel delay expansion time T_{delay} to ensure that the effective data is free from the interference caused by the previous data symbol.

In accordance with the Institute of Electrical and Electronics Engineers (IEEE) 802.11n standard, the guard interval can be either a long guard interval, e.g., 800 ns, or a short guard interval, e.g., 400 ns. A longer guard interval provides a stronger capability to limit ISI. Drawback to longer guard intervals, however, includes greater power consumption and reduced data transmission efficiency. For example, in 802.11n the throughput when using long guard intervals is 65 Mbps, while the throughput when using short guard intervals improves to 72.2 Mbps. Therefore, it is necessary to propose a switching method and module between the long guard interval and short guard interval, which are capable of performing an adaptive selection in accordance with the desired balance of ISI control and throughput.

### SUMMARY OF THE INVENTION

The present invention proposes a method for switching between a long guard interval and a short guard interval and the module using the same. The present invention effectively raises anti-ISI capability and throughput.

The method for switching between a long guard interval and a short guard interval in accordance with one embodiment of the present invention comprises the steps of: receiving a first data symbol, the first data symbol including a cyclic preamble and an effective data; generating a second data symbol in accordance with the cyclic preamble, the second data symbol including an effective data; respectively measuring portions of the first and second data symbols to generate a first measurement value and a second measurement value; and comparing the first and second measurement values with a threshold value to generate an output value, wherein the output value is used to select a long guard interval or a short guard interval.

The method for switching from a long guard interval to a short guard interval in accordance with one embodiment of the present invention comprises the steps of: receiving a preamble to generate a channel estimation parameter; calculating a cross-correlation of channels between adjacent subcarriers in accordance with the channel estimation parameter; determining whether the cross-correlation is greater than a threshold value; and switching guard intervals of subsequent data symbols to a short guard interval if the determination is affirmative.

The module for switching between a long guard interval and a short guard interval in accordance with one embodiment of the present invention comprises a signal processing unit, a measurement unit, a comparison unit and a switching unit. The module receives a first data symbol, and the data symbol has one of a long guard interval and a short guard interval. The signal processing unit is configured to generate a second data symbol in accordance with the first data symbol. The measurement unit is configured to measure portions of the first and second data symbols in order to generate a first measurement value and a second measurement value. The comparison unit is configured to generate an output signal by comparing the first and second measurement values with a threshold value. The switching unit is configured to selectively switch guard intervals of subsequent data symbols in accordance with the output signal.

### BRIEF DESCRIPTION OF THE DRAWINGS

The invention will be described according to the appended drawings in which:

FIG. 1A shows a data frame in the time domain;

FIG. 1B further describes each data symbol in detail;

FIG. 2 shows a structure of a guard interval switching module in accordance with one embodiment of the present invention;

FIG. 3 shows a flow chart of switching between a long guard interval and a short guard interval;

FIG. 4 shows an example of switching guard intervals;

FIG. 5 shows another flow chart of switching between a long guard interval and a short guard interval;

FIG. 6 shows a frame structure specified in the IEEE 802.11a standard; and

FIG. 7 shows detailed sub-steps of step S52.

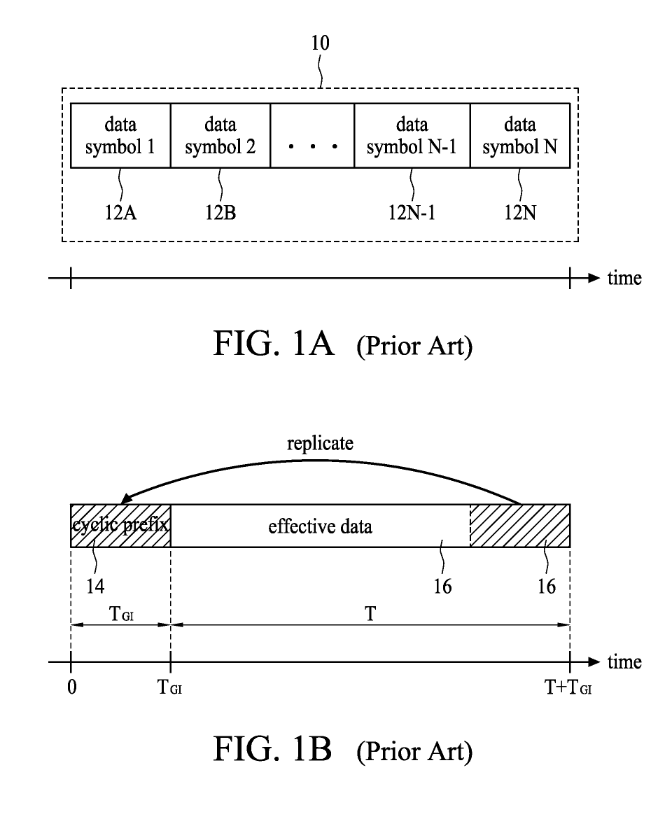

### PREFERRED EMBODIMENT OF THE PRESENT INVENTION

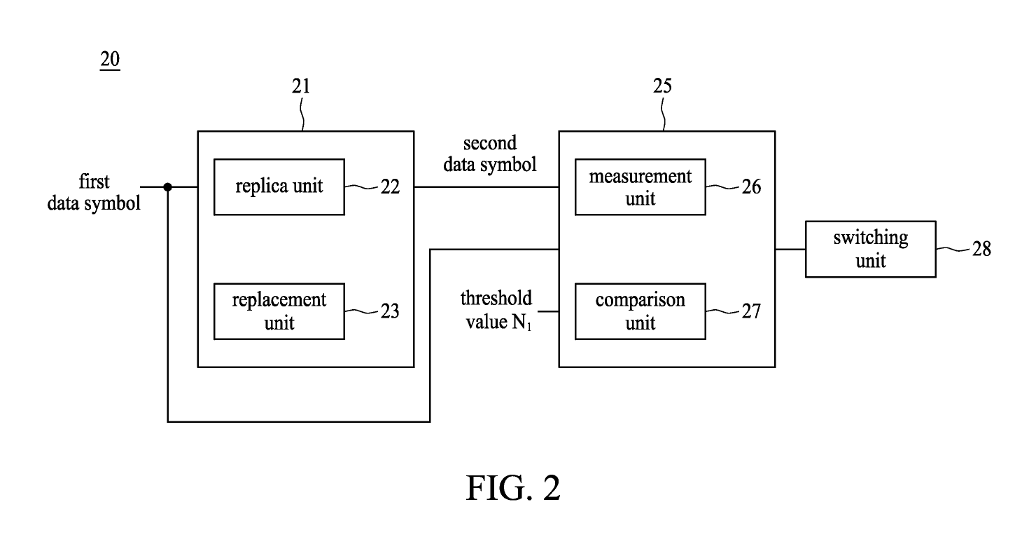

FIG. 2 shows a structure of a guard interval switching module 20 in accordance with one embodiment of the present invention, which comprises a signal processing unit 21, a measurement module 25 and a switching unit 28. The signal processing unit 21 includes a replica unit 22 and a replacement unit 23. The measurement module 25 includes a measurement unit 26 and a comparison unit 27. The signal processing unit 21 is used to receive a first data symbol in order to generate a second data symbol. The measurement module 25 is used to measure and compare the data of the first and second data symbols. The switching unit 28 is used to switch guard intervals of subsequent data symbols.

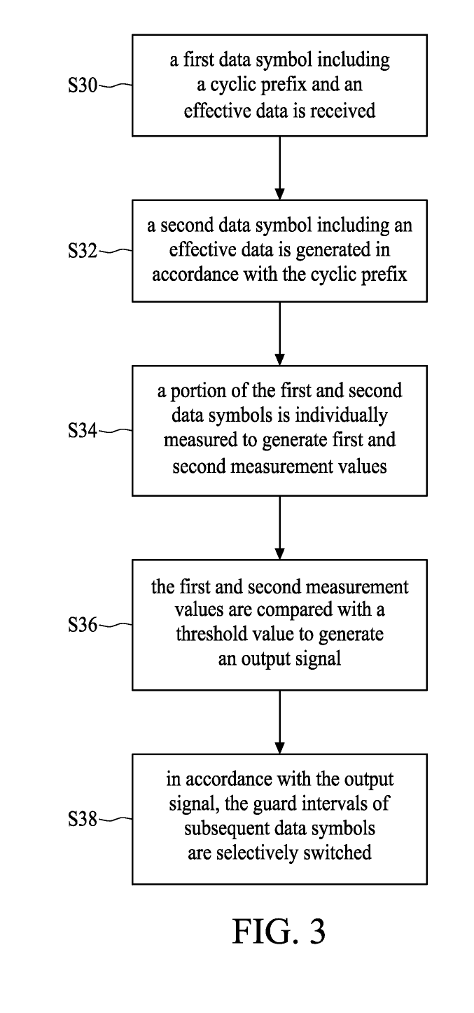

FIG. 3 shows a flow chart of switching between a long guard interval and a short guard interval. In step S30, a first data symbol including a cyclic prefix and an effective data is received. In step S32, a second data symbol including an effective data is generated in accordance with the cyclic prefix. In step S34, a portion of the first and second data symbols is respectively measured to generate first and second measurement values. In step S36, the first and second measurement values are compared with a threshold value to generate an output signal. In step S38, in accordance with the output signal, the guard intervals of subsequent data symbols are selectively switched. Hereinafter, referring to FIGS. 2, 3 and 4, the detailed switching method in accordance with embodiments of the present invention is introduced.

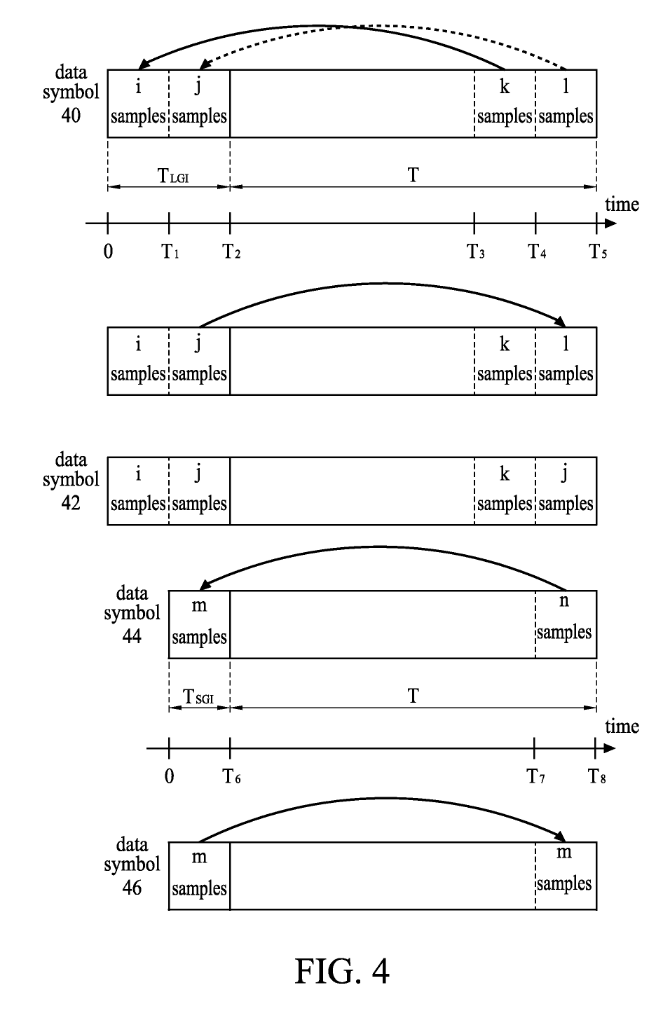

First, in step S30 of FIG. 3, a receiver unit (not shown) is used to receive a first data symbol, which is denoted in FIG. 4 as numeral 40. The data symbol 40 includes a cyclic prefix having a long guard interval T_{LGI} and an effective data having a symbol duration T. There are i samples during 0 to T1 of the long guard interval T_{LGI}, while there are j samples during T₁ to T₂, wherein i and j are integers. The i samples and j samples are generated by periodically replicating k samples during T₃ to T₄ and 1 samples during T₄ to T₅ of the tail portion of the symbol interval T through a guard interval embedding unit (not shown) before transmitting.

In step S32, a second data symbol is obtained in accordance with the cyclic prefix. The second data symbol is denoted by numeral 42. The replica unit 22 in FIG. 2 replicates j samples during the long guard interval T_{LGI} of the received data symbols 40, and the data symbol 42 is obtained by replacing 1 samples during the symbol interval T of the data symbol 40 with replicated j samples through the replica unit 23.

Subsequently, in step S34, first and second measurement values are respectively generated in accordance with a portion of the data symbols 40 and 42, e.g., effective data. These measurement values may be signal-to-noise ratio (SNR), or can further generate an error vector magnitude (EVM) through the measurement unit 26, e.g., a vector signal analyzer (VSA). In step S36, the comparison unit 27 is compared with a threshold value N₁ in accordance with the measurement value of the data symbols 40 and 42. In one embodiment of the present invention, the comparison is performed as follows: first, the absolute value of the difference between the EVM based on the data symbol 40 and EVM based on the data symbol 42 is compared with the threshold value; second, if the difference is smaller than the threshold value, then the data symbols in the transmitter end choose a short guard interval T_{SGI}.

In one embodiment of the present invention, the received first data symbol in step S30 can be a data symbol 44 which includes a cyclic prefix having a short guard interval T_{SGI} and effective data having a symbol interval T, as shown in FIG. 4. The data symbol 44 has m samples during 0 to T₆ of the short guard interval T_{SGI}, while the m samples are obtained by periodically replicating n samples during T₇ to T₈ of the tail portion of the symbol interval T through a guard interval embedding unit of a transmitter.

Similarly, in step S32, a second data symbol is obtained in accordance with the cyclic prefix. The second data symbol is denoted by numeral 46 in FIG. 4. The samples during symbol intervals T₇ to T₈ of the data symbol 46 are generated by replicating m samples of the original short guard interval T_{SGI} in accordance with the data symbol 44 after going through the channels.

Subsequently, in step S34, a portion of the data symbols 44 and 46 such as effective data is measured. The measurement includes measuring the EVM of the data symbol 44 after going through channels and EVM of the data symbol 46. Next, in step S36, the comparison unit 27 compares the measurement values of the data symbols 44 and 46 with a threshold value N₂. For example, the absolute value of the difference between the EVM based on the data symbol 44 and EVM based on the data symbol 46 is compared with the threshold value N₂. An absolute value greater than the threshold value N₂ indicates that ISI is occurring, and a switch to the long guard interval T_{LGI} is needed.

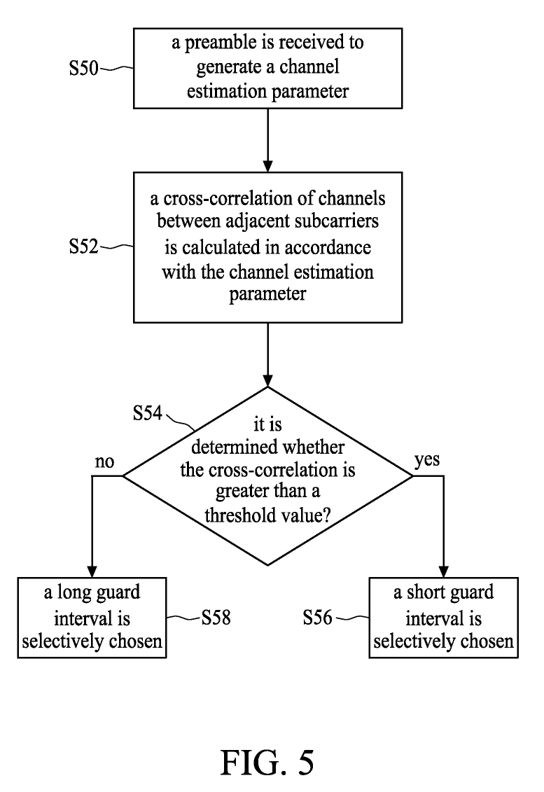

In one embodiment of the present invention, the switching between different guard intervals can be determined by calculating a cross-correlation of channels between the subcarriers. FIG. 5 shows another flow chart of switching different guard intervals in accordance with one embodiment of the present invention. In step S50, a preamble is received to generate a channel estimation parameter. In step S52, a cross-correlation of channels between adjacent subcarriers is calculated in accordance with the channel estimation parameter. In step S54, it is determined whether the cross-correlation is greater than a threshold value. In step S56, if the result of the prior step is affirmative, a short guard interval is selectively chosen. Otherwise, in step S58, a long guard interval is selectively chosen.

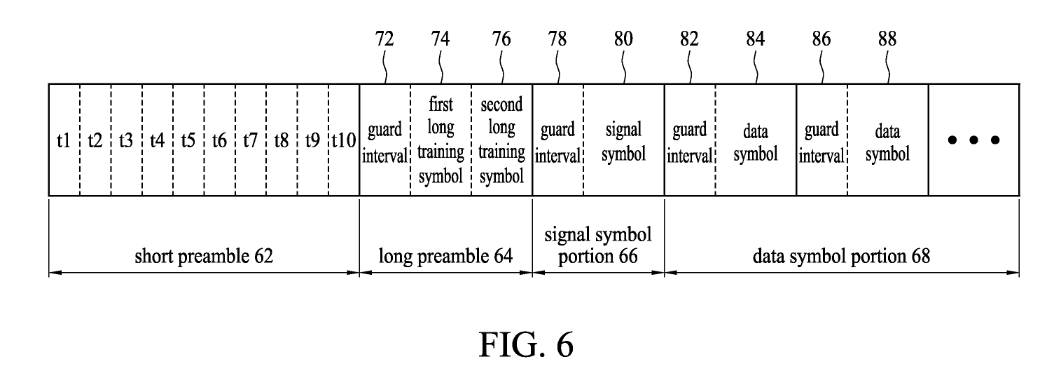

In the 802.11n wireless communication standard, each channel has 64 subcarriers, and the frequency spacing between adjacent subcarriers is 312.5 KHz (20 MHz/64, where 20 MHz is the bandwidth of the channel). Among the 64 subcarriers, there are 56 non-zero subcarriers, wherein 52 data subcarriers are used to deliver data, while the other 4 data subcarriers are used to deliver pilot tones. Each subcarrier delivers 312.5K symbols per second. The data to be transmitted are placed in a 3.2 μs symbol interval and selectively added with a cyclic prefix having a short guard interval 400 ns or a long guard interval 800 ns to prevent the ISI effect. In addition, to be compatible with the IEEE 802.11a standard, a system complying with the IEEE 802.11n standard has to use the preamble symbol adopted in the IEEE 802.11a standard to execute a channel estimation. FIG. 6 shows a frame structure specified in the IEEE 802.11a standard, where the frame structure is divided into four regions. The first region is a short preamble 62, the second region is a long preamble 64, the third region is a signal symbol region 66 and the fourth region is a data symbol region 68. A plurality of guard intervals 72, 78, 82 and 86 are inserted into the regions. The short preamble 62 includes short training symbols t1-t10, which are usually used to conduct frame detection, coarse timing synchronization and estimation of the carrier frequency offset (CFO). The long preamble 64 includes a first long training symbol 74 and a second long training symbol 76, which are usually used to conduct a fine timing synchronization and channel estimation. The signal symbol region 66 includes signal symbol 80, which is used to transmit data rate, number of data, method of modulation, etc. The data symbol region 68 includes data symbols 84 and 88, which are used to transmit data.

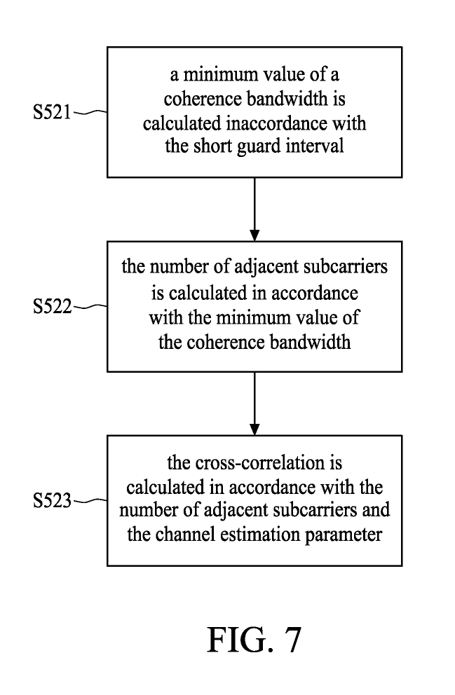

Referring to the flow chart in FIG. 5, in step S50, the preamble, e.g., the first long training symbol 74 and the second long training symbol 76, is first received to generate the channel estimation parameter h(x). Next, in step S52, the cross-correlation of channels between adjacent subcarriers is calculated in accordance with the channel estimation parameter. FIG. 7 shows detailed sub-steps of step S52. In step S521, a minimum value of a coherence bandwidth Δf_{C} is calculated in accordance with the short guard interval. In step S522, the number of adjacent subcarriers is calculated in accordance with the minimum value of the coherence bandwidth Δf_{C}. In step S523, the cross-correlation is calculated in accordance with the number of adjacent subcarriers and the channel estimation parameter. The following takes a system complying with the 802.11n standard as an example. Assuming that a short guard interval such as 400 ns is chosen, the channel delay expansion needs to be smaller than the short guard interval. Because the channel delay expansion and the coherence bandwidth Δf_{C} constitute a reciprocal relationship, the minimum value of the coherence bandwidth Δf_{C} can be calculated in accordance with the short guard interval. For example, if the short guard interval is 400 ns, the minimum value of the coherence bandwidth Δf_{C} is 2.5 MHz. Because the frequency spacing of adjacent subcarriers in 802.11n is 312.5 KHz, the bandwidth of 2.5 MHz includes 8 subcarriers.

In step S52, because all data in the coherence bandwidth Δf_{C} have substantially the same magnitude gain and linear phase relationship, i.e., a high cross-correlation, it can be easily found whether the subcarriers are located in the same coherence bandwidth Δf_{C} in accordance with the cross-correlation of channels between adjacent subcarriers. The cross-correlation of channels between adjacent subcarriers can be calculated by the following equation:

$$C = {\sum }_{K} \frac{h ( k )}{\vert h ( k ) \vert} \times \frac{{h}^{*} ( k + D )}{\vert {h}^{*} ( k + D ) \vert} \qquad ( 1 )$$

where h(k) denotes a channel estimation parameter of k^{th} subcarrier; h*(k+D) denotes a complex conjugate of the channel estimation parameter of (k+D)^{th} subcarrier, where k and D are integers, and in this embodiment D is equal to 8. It can be found from equation (1) that the channel correlation value C is a normalized function value.

Next, in step S54, it is determined whether the channel correlation value C is greater than a threshold value N₃. In step S56, if the channel correlation value C is greater than the threshold value N₃, indicating that the channel delay expansion is smaller than the short guard interval T_{SGI}, then the data symbols to be transmitted at the transmitter end need to be selectively added with the short guard interval T_{SGI}. In step S58, if the channel correlation value C is smaller than the threshold value N₃, indicating that the channel delay expansion is greater than the short guard interval T_{SGI}, then the data symbols to be transmitted at the transmitter end need to be selectively added with the long guard interval T_{LGI}.

The above-described embodiments of the present invention are intended to be illustrative only. Numerous alternative embodiments may be devised by persons skilled in the art without departing from the scope of the following claims.

What is claimed is:

1. A method for switching between a long guard interval and a short guard interval, comprising the steps of:
receiving a first data symbol, the first data symbol including a cyclic preamble and an effective data;
generating a second data symbol in accordance with the cyclic preamble, the second data symbol including an effective data;
respectively measuring portions of the first and second data symbols to generate a first measurement value and a second measurement value; and
comparing the first and second measurement values with a threshold value to generate an output value, wherein the output value is used to choose a long guard interval or a short guard interval.

2. The method of claim 1, wherein the cyclic preamble includes a long guard interval, a first portion of the long guard interval includes i samples, a second portion of the long guard interval includes j samples, and k samples in a tail portion of the second data symbol are the same as the j samples, wherein i, j and k are integers.

3. The method of claim 1, wherein the cyclic preamble includes a short guard interval, the short guard interval includes m samples, and k samples in a tail portion of the second data symbol are the same as the m samples, wherein m and k are integers.

4. The method of claim 1, wherein the portions of the first and second data symbols are the effective data of the first and second data symbols.

5. The method of claim 1, wherein the first and second measurement values represent signal-to-noise ratio (SNR) or error vector magnitude (EVM).

6. The method of claim 1, wherein the comparing step comprises comparing an absolute value of a difference between the first measurement value and the second measurement value with the threshold value.

7. The method of claim 6, wherein when the absolute value is smaller than the threshold value, guard intervals of subsequent data symbols are switched to a short guard interval; when the absolute value is greater than the threshold value, guard intervals of subsequent data symbols are switched to a long guard interval.

8. A method for switching from a long guard interval to a short guard interval, comprising the steps of:
receiving a preamble to generate a channel estimation parameter;
calculating a cross-correlation of channels between adjacent subcarriers in accordance with the channel estimation parameter;
determining whether the cross-correlation is greater than a threshold value; and
switching guard intervals of subsequent data symbols to a short guard interval if the determination is affirmative.

9. The method of claim 8, wherein the calculating step comprises the steps of:
calculating a minimum value of a coherence bandwidth in accordance with the short guard interval;
calculating the number of adjacent subcarriers in accordance with the minimum value of a coherence bandwidth;
calculating the cross-correlation in accordance with the number of adjacent subcarriers and the channel estimation parameter.

10. The method of claim 9, wherein the step of calculating the number of adjacent subcarriers is performed in accordance with a frequency spacing of the subcarriers.

11. The method of claim 8, wherein the preamble and the short guard interval comply with the Institute of Electrical and Electronics Engineers (IEEE) 802.11a or IEEE 802.11n standard.

12. A module for switching between a long guard interval and a short guard interval, the module receiving a first data symbol, the data symbol having one of a long guard interval and a short guard interval, the module comprising:
a signal processing unit configured to generate a second data symbol in accordance with the first data symbol;
a measurement unit configured to measure portions of the first and second data symbols in order to generate a first measurement value and a second measurement value;
a comparison unit configured to generate an output signal by comparing the first and second measurement values with a threshold value; and
a switching unit configured to selectively switch guard intervals of subsequent data symbols in accordance with the output signal.

13. The module of claim 12, wherein the signal processing unit includes:
a replica unit configured to replicate a plurality of samples in a guard interval of the first data symbol; and
a replacement unit configured to generate a second data symbol by replacing a plurality of samples in a tail portion of the first data symbol through the replica unit.

14. The module of claim 12, wherein the portions of the first and second data symbols are respectively the effective data of the first and second data symbols.

15. The module of claim 12, wherein the measurement unit is a signal analyzer, and the first and second measurement values represent an error vector magnitude (EVM).

16. The module of claim 15, wherein the comparison unit further comprises an operation unit for comparing an absolute value of a difference between the first measurement value and the second measurement value with the threshold value.

17. The module of claim 16, wherein when the absolute value is smaller than the threshold value, guard intervals of subsequent data symbols are switched to a short guard interval; when the absolute value is greater than the threshold value, guard intervals of subsequent data symbols are switched to a long guard interval.
